(19) United States
(12) Patent Application Publication
(10) Pub. No.: US 2025/0150951 A1
(43) Pub. Date: May 8, 2025

(54) COMMUNICATION APPARATUS, COMMUNICATION METHOD OF COMMUNICATION APPARATUS, AND STORAGE MEDIUM

(71) Applicant: CANON KABUSHIKI KAISHA, Tokyo (JP)

(72) Inventor: MASATOMO OUCHI, Tokyo (JP)

(21) Appl. No.: 19/012,310

(22) Filed: Jan. 7, 2025

Related U.S. Application Data
(63) Continuation of application No. PCT/JP2023/023247, filed on Jun. 23, 2023.

(30) Foreign Application Priority Data
Jul. 8, 2022 (JP) 2022-110741

(51) Int. Cl. H04W 48/16; H04W 84/12

(52) U.S. Cl. CPC H04W 48/16; H04W 84/12

(57) ABSTRACT

A communication apparatus transmits a channel access parameter request to a server, a part of information or all pieces of information from among time-sequential data of any one of pieces of information in unit time being included in the channel access parameter request, the information including an application attribute, the number of stations (STAs) connected to an access point (AP), a channel usage rate, the number of re-transmissions, a throughput, an access delay, jitter, fairness, Quality of Service (QOS), and Traffic Specification (TSPEC) information prescribed in IEEE802.11, wherein the request requests for inference of channel access parameters to be used for communication between the communication apparatus and other communication apparatus, acquires the channel access parameters from the server, and notifies the other communication apparatus of the channel access parameters acquired from the server.

### CROSS-REFERENCE TO RELATED APPLICATIONS

This application is a Continuation of International Patent Application No. PCT/JP2023/023247, filed Jun. 23, 2023, which claims the benefit of Japanese Patent Application No. 2022-110741, filed Jul. 8, 2022, both of which are hereby incorporated by reference herein in their entirety.

### BACKGROUND

### Technical Field

The present disclosure relates to a communication apparatus conforming to the IEEE802.11 standard.

### Description of Related Art

The IEEE802.11 series standard is known as a communication standard related to a Wireless Local Area Network (hereinafter referred to as a WLAN). In the technique discussed in Japanese Patent Application Laid-Open No. 2018-50133, the latest IEEE802.11be standard implements high-peak throughput and low-delay communication by using a Multi-Link technique.

As the successor standard of the IEEE802.11be standard, an introduction of Artificial Intelligence (AI) and Machine Learning (ML) has been studied.

In Enhanced Distributed Channel Access (EDCA) as a wireless channel access method conforming to the IEEE802.11 standard, an Access Point (AP) notifies a station (STA) of parameters, and the STA determines a radio wave transmission timing and a maximum transmission time in accordance with the parameters, and controls the transmission power and the modulation method to perform a transmission operation.

### SUMMARY

While machine learning may possibly be used to optimize this channel access, there have been no frame configuration and no data collection method for data collection that is for implementation of machine learning in channel access, and no method for training data usage.

In view of the above-described issues, the present disclosure is directed to enabling data collection and data communication for the data collection to be utilized in machine learning in channel access.

According to an aspect of the present invention, a communication apparatus transmits a channel access parameter request to a server, a part of information or all pieces of information from among time-sequential data of any one of pieces of information in unit time being included in the channel access parameter request, the information including an application attribute, the number of stations (STAs) connected to an access point (AP), a channel usage rate, the number of re-transmissions, a throughput, an access delay, jitter, fairness, Quality of Service (QOS), and Traffic Specification (TSPEC) information prescribed in IEEE802.11, wherein the request requests for inference of channel access parameters to be used for communication between the communication apparatus and other communication apparatus, acquires the channel access parameters from the server, and notifies the other communication apparatus of the channel access parameters acquired from the server.

Further features of the present invention will become apparent from the following description of exemplary embodiments with reference to the attached drawings.

### BRIEF DESCRIPTION OF THE DRAWINGS

FIG. 1 is a diagram illustrating an example of a network configuration.

FIG. 2 is a diagram illustrating an example of a hardware configuration of an access point (AP) and a station (STA).

FIG. 3 is a diagram illustrating examples of functional blocks including the AP and the STA.

FIG. 4 is a conceptual view illustrating a structure using a training model including input data, a training model, and output data.

FIG. 5 illustrates an example of a system processing procedure according to the present disclosure.

FIG. 6 is a flowchart illustrating processing of the AP according to the present disclosure.

FIG. 7 is a flowchart illustrating processing of the STA according to the present disclosure.

FIG. 8 is a flowchart illustrating processing of a data collection server according to the present disclosure.

FIG. 9 is a flowchart illustrating processing of an inference server in a training phase according to the present disclosure.

FIG. 10 is a flowchart illustrating processing of the inference server in an inference phase according to the present disclosure.

FIG. 11 is a diagram illustrating an example frame of a channel access statistical information request of the AP according to the present disclosure.

FIG. 12 is a diagram illustrating an example frame of a channel access statistical information report of the STA according to the present disclosure.

### DESCRIPTION OF THE EMBODIMENTS

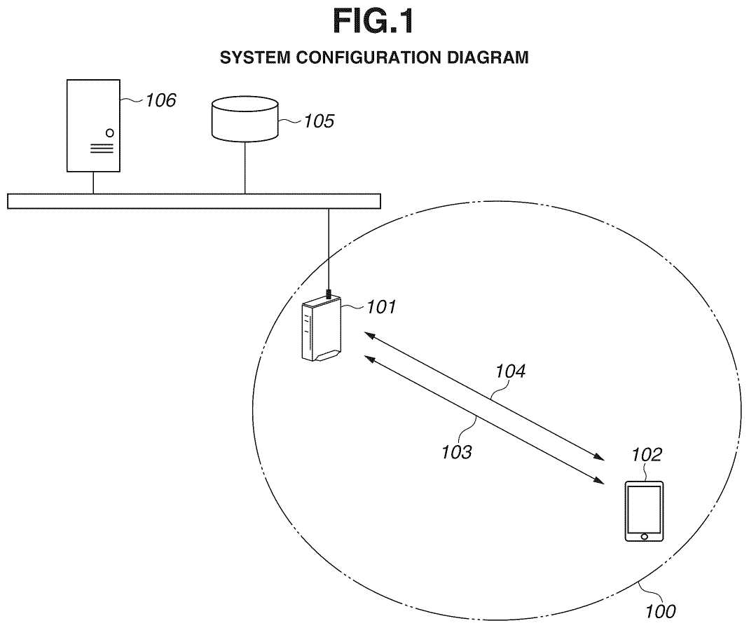

FIG. 1 illustrates an example of a network configuration. A wireless communication system illustrated in FIG. 1 is a wireless network including an access point (AP) 101, a station (STA) 102, a data collection server 105, and an inference server 106. The AP 101 has a similar function to the STA 102 except for a relay function and is one form of the STA 102.

The AP 101 communicates with each STA 102 in accordance with a wireless communication method conforming to the IEEE802.11 standard. STAs 102 in a circle 100 indicating signal transmission coverage of the AP 101 are able to communicate with the AP 101. According to the present exemplary embodiment, the AP 101 and each STA 102 communicate with each other in accordance with the IEEE802.11 standard. The AP 101 establishes wireless links 103 and 104 with each STA 102 via a predetermined association process. While FIG. 1 illustrates an example of a multi-link connection using two different links, the number of wireless links may be one, or more than two.

The AP 101 connects with the data collection server 105 and the inference server 106 via the Internet. The AP 101 may connect with the data collection server 105 and the inference server 106 in any desired form. The number of STAs 102 and the number of APs 101 may be two or more. For example, a multi-AP configuration may be configured to control the time and frequency to be used by each basic service set (BSS).

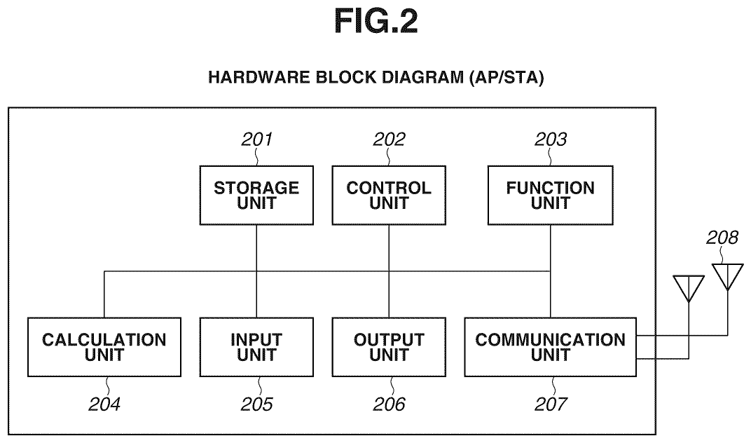

FIG. 2 illustrates a hardware configuration of the AP 101 and the STA 102 according to the present disclosure. As an example, the hardware configuration includes a storage unit 201, a control unit 202, a function unit 203, a calculation unit 204, an input unit 205, an output unit 206, a communication unit 207, and an antenna 208.

The storage unit 201 includes memories, such as a read only memory (ROM) and a random access memory (RAM), and stores programs for various operations (described below) and various information, such as communication parameters, for wireless communications. Examples of storage media applicable as the storage unit 201 include not only the ROM and RAM but also a flexible disk, a hard disk, an optical disk, a magneto-optical disk, a compact disc read only memory (CD-ROM), a compact disc recordable (CD-R), a magnetic tape, a nonvolatile memory card, and a digital versatile disc (DVD). The storage unit 201 may also include a plurality of memories.

The control unit 202 includes, for example, processors such as a central processing unit (CPU) and a micro processing unit (MPU), an application specific integrated circuit (ASIC), a digital signal processor (DSP), and a field programmable gate array (FPGA). The CPU executes a program stored in the storage unit 201 to control the AP 101 and the STA 102. The control unit 202 may control the AP 101 through cooperation between the program and an operating system (OS) stored in the storage unit 201. The control unit 202 may include a plurality of processors, such as a multi-core, to control the AP 101 and the STA 102.

The control unit 202 controls the function unit 203 to perform predetermined processing, such as the AP and STA functions, imaging, printing, and projection. The function unit 203 is a hardware component that is used by the AP 101 and the STA 102 to perform predetermined processing.

The calculation unit 204 includes, for example, a processor, such as a graphics processing unit (GPU) and a tensor processing unit (TPU), an application specific integrated circuit (ASIC), a digital signal processor (DSP), and a field programmable gate array (FPGA).

Referring to the example illustrated in FIG. 1, while the data collection server 105 and the inference server 106 that are used for machine learning are prepared separately from the AP 101 and the STA 102, the functions of these servers may be integrated in the AP 101 and the STA 102. In this case, the calculation unit 204 operates as a hardware component for inference calculations using the result of machine learning and for calculating machine learning itself. The TPU is an example of a systolic array type hardware processor that is dedicated for machine learning, and is provided with such calculation resources as buffer resistors disposed adjacently to a product sum calculation unit and a product sum calculator, and activation functions implemented by hardware. The TPU includes an instruction decoder for interpreting a TPU instruction for designation of a calculation flow, to control the above-described calculation resources. The TPU functions as what is called a neural processing unit (NPU).

These processors may share some calculations to perform calculations in cooperation with the control unit 202. Since the GPU and TPU are capable of performing effective calculations through parallel processing of a large amount of data, processing using the GPU and TPU is effective when performing training a plurality of times by using a training model, such as deep learning. In the processing by a training unit 333 of the inference server 106 according to the present exemplary embodiment, the GPU and TPU are used as the calculation unit 204 in addition to the control unit 202. More specifically, in execution of a training program including the training model, the control unit 202 and the calculation unit 204 perform training by calculations in collaboration with each other. The processing of the training unit 333 may be performed only by the control unit 202 or the calculation unit 204. An inference unit 334 may also use the calculation unit 204 like the training unit 333.

The input unit 205 receives various operations from the user. The output unit 206 provides the user with various outputs. Outputs provided by the output unit 206 include at least one of display on a screen, sound output by a speaker, and vibration output. Both the input unit 205 and the output unit 206 may be implemented by a single module, such as a touch panel.

The communication unit 207 is configured to execute wireless communication conforming to the successor standard of the IEEE802.11be standard, aiming for a maximum transmission rate of 90 to 100 Gbps or higher. The successor standard of the 802.11be standard aims for supporting high-reliability and low-latency communications as the next target to be achieved. Taking the above description into account, according to the present exemplary embodiment, the successor standard of the IEEE802.11be standard aiming for a maximum transmission rate of 90 to 100 Gbps or higher is tentatively referred to as IEEE802.11 HR (High Reliability).

The name IEEE802.11 HR is given for convenience in consideration of targets to be achieved by the successor standard and features of the relevant standard. The name may be changed when the standard is established. The scope of the present specification and the appended claims are essentially the successor standard of the 802.11be standard, and are applicable to all of successor standards that support wireless communications.

Further, the communication unit 207 performs encoding/decoding and modulation/demodulation processing for wireless communication data conforming to a series of the IEEE802.11 standards. The communication unit 207 also controls Wi-Fi-based wireless communications and Internet Protocol (IP) communications. The communication unit 207 further controls the antenna 208 to transmit and receive wireless signals for wireless communications.

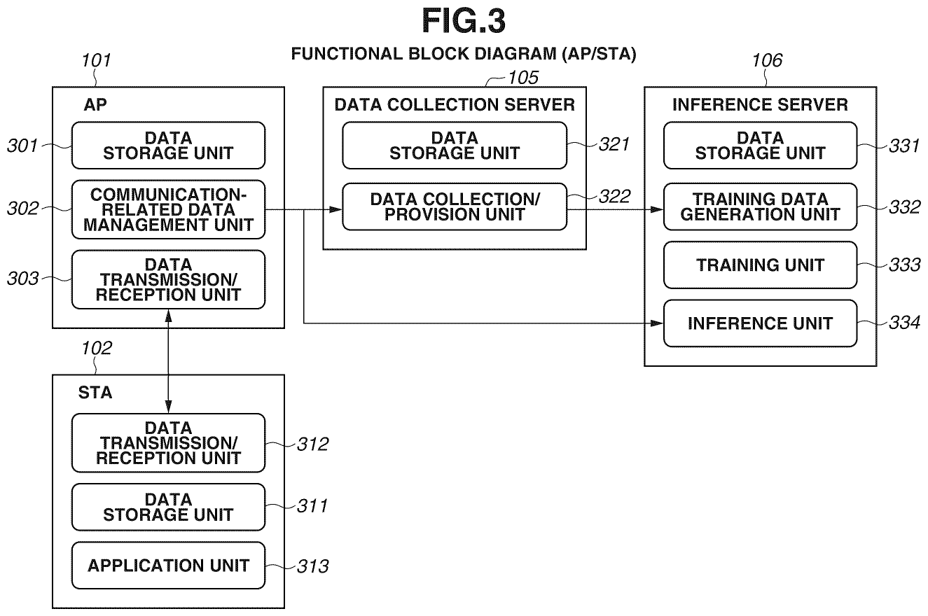

FIG. 3 illustrates a functional block of the training system according to the present disclosure. The STA 102 includes a data transmission/reception unit 312 for transmitting and receiving surrounding information collected by the communication unit 207 and information accumulated in the storage unit 201, via the communication unit 207 and the antenna 208. An application unit 313 is a software function unit for performing predetermined processing of the function unit 203, such as imaging, printing, and projection. A data storage unit 311 is used as the storage unit 201.

The AP 101 includes a data transmission/reception unit 303 for receiving data transmitted by the STA 102 and also transmitting data from the AP 101 to the STA 102. The AP 101 and the STA 102 use the communication unit 207 and the antenna 208 for these data communications. The AP 101 also includes a data storage unit 301 for storing data, in the storage unit 201. The AP 101 also expands the storage unit 201 and the control unit 202 and includes a communication-related data management unit 302. The communication-related data management unit 302 cooperates with the data collection server 105 and the inference server 106 to transmit input data to be used in training, receive the result of inference, and communicate relevant requests.

The data collection server 105 accumulates data collected from the AP 101 and other APs in a data storage unit 321. The data collection server 105 transmits the accumulated data to the inference server 106, via a data collection/provision unit 322, as required.

The inference server 106 receives input information and result data obtained from the data collection server 105 and generates a training model via a training data generation unit 332 and a training unit 333. The inference server 106 stores the generated training model in a data storage unit 331. In response to receipt of an inference value request from the AP 101, the inference server 106 calculates the inference values by using the training result via the inference unit 334, and returns the result to the AP 101. In a case where the functions of the data collection server 105 and the inference server 106 that are used for machine learning are incorporated into the AP 101 and the STA 102, a single apparatus, such as the AP 101 and the STA 102, will include all of the functions illustrated in FIG. 3. On the other hand, in a case where the data collection server 105 and the inference server 106 that are used for machine learning are provided as different apparatuses from the AP 101 and the STA 102, the data collection and inference functions will be performed by these servers as different apparatuses, as described above. While, in the example case in FIG. 3, the servers as different apparatuses perform both training and inference, the present exemplary embodiment is not limited thereto. The inference processing may be implemented by the AP 101. In this case, the inference server 106 transmits trained model data generated based on the received input and output data, to the AP 101. In this case, the AP 101 is configured to have the function of the inference unit 334. The AP 101 stores the trained model data received from the inference server 106. The inference unit 334 of the AP 101 is configured to calculate the inference values by using the inference input data and the trained model data obtained from the surrounding environment where the AP 101 itself collects data and from the operating status.

The training unit 333 may include an error detection unit and an updating unit. The error detection unit obtains an error between the output data output from the output layer of the neural network in response to the input data input to an input layer, and teacher data. The error detection unit may calculate an error between the output data output from the neural network and the teacher data by using a loss function. The updating unit updates a coupling weighting coefficient between nodes of the neural network to minimize an error obtained by the error detection unit. The updating unit updates the coupling weighting coefficient, for example, by using the error back propagation method. The error back propagation method adjusts the coupling weighting coefficient between nodes of each neural network to minimize the above-described error.

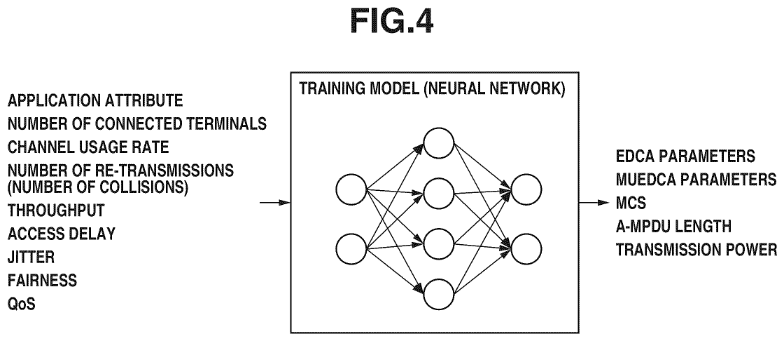

FIG. 4 is a conceptual view illustrating an input/output configuration using the training model according to the present exemplary embodiment.

The overview of the output data illustrated in the conceptual diagram in FIG. 4 will be described below.

Enhanced Distributed Channel Access (EDCA) as an expanded version of Distributed Coordination Function (DCF), one of channel access methods conforming to the IEEE802.11 standard, will be described below.

In the EDCA method, a terminal detects the idle (unused) state of a wireless medium and, after a predetermined frame interval (Interframe Space), decrements the backoff counter. In a case where the wireless medium is in the idle state when the backoff counter counts 0, data is transmitted till the period of Transmission Opportunity (TXOP) Limit (described below).

In this case, the predetermined frame interval is Arbitration Interframe Space Number (AIFSN) multiplied by the predetermined unit time (a time slot, such as 10μ or 16 μ seconds) defined by the IEEE802.11 standard.

The backoff counter is a variable to be decremented each time a predetermined unit time has elapsed when the wireless medium is in the idle state. This initial value is set at random within the range of Contention Window (CW). CWmin and CWmax indicate the range of CW. The relation between ECWmin and ECWmax as EDCA parameters is represented by the following formula:

$$CW min = {2}^{ECWmin} - 1$$

$$CW max = {2}^{ECWmax} - 1$$

TXOP Limit indicates the period during which data is transmitted at intervals of Short Interframe Space (SIFS). In a case where TXOP Limit is 0 (zero), a terminal transmits one Medium access control Protocol Data Unit (MPDU), or QoS Null.

AIFSN, ECWmin, ECWmax, and TXOP Limit form an information element EDCA Parameter Set. The AP 101 informs each BSS of EDCA Parameter Set via a Beacon frame and notifies the STA 102 of EDCA Parameter Set via Probe Response.

The AP 101 separately notifies the STA 102 of other output data including Aggregate Medium access control Protocol Data Unit (A-MPDU), transmission power, and Modulation and Coding Scheme (MCS). A-MPDU indicates the maximum length, and may be optionally determined to be a value equal to or smaller than the maximum length by the STA 102.

Table 1 illustrates an example of a data set for training that associates the input parameter with the correct answer parameter.

| | Input data | | | | | | | |
|---|---|---|---|---|---|---|---|---|
| | | Number of | | | Teacher data | | | |
| | | STAs | Number of | Channel | Number of re- | | Maximum | |
| Training | Application | operating | connected | usage | transmissions | Throughput | access delay | Maximum |
| data ID | attribute | application | terminals | rate (%) | in unit time | (Mbps) | (msec.) | jitter |
| 1 | Miracast | 2 | 8 | 70 | 2 | 8 | 20 | 15 |
| 2 | VoIP | 4 | 6 | 60 | 2 | 0.03 | 30 | 20 |
| 3 | Game | 2 | 7 | 80 | 1 | 15 | 10 | 10 |
| . . . | | | | | . . . | . . . | . . . | . . . |
| N | Backup | 1 | 5 | 50 | 1 | 0.5 | 100 | 100 |

The application attribute in Table 1 indicates, for example, VOIP (voice communication), Miracast, game, and backup. These attributes are predetermined between the AP 101 and the STA. Instead of the application name, an access category, such as AC_VO, AC_VI, AC_BE, and AC_BK according to the IEEE802.11 standard may be used.

The number of connected terminals illustrated in Table 1 is the number of terminals connected with the AP 101. According to the IEEE802.11 standard, “Station Count” of BSS Load indicates the number of connected terminals.

The channel usage rate is indicated by “Channel Utilization” of BSS Load, which refers to the ratio with which the AP 101 detects that the wireless medium is busy. This value decreases with decreasing number of transmissions by the terminal.

The number of re-transmissions in unit time indicates the degree of the occurrence of collision. Generally, the collision rate decreases with an increase in width of CW. On the contrary, with an increase in width of CW, the time to be decremented from the backoff counter, i.e., the idle time, increases, and the channel usage rate decreases.

The throughput may be the ratio of the real throughput to the throughput performed by applications. A larger value of the throughput is more desirable.

The access delay refers to the time duration since the time when the application unit 313 registers transmission data to the data transmission/reception unit 312 till the time when the data is actually transmitted to the wireless medium. A smaller value of the access delay is more desirable.

Jitter refers to fluctuations of the transmission interval time. Desirably, jitter is small with respect to an application having the Constant Bit Rate (CBR) characteristics, such as VoIP.

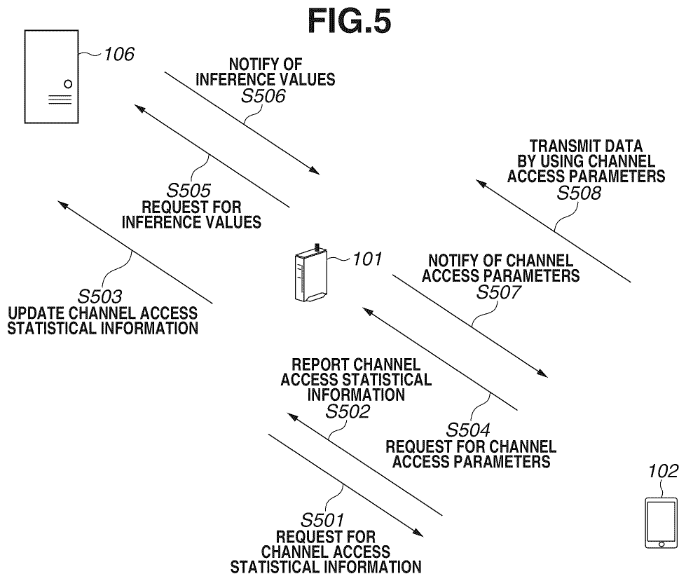

FIG. 5 illustrates operations of the system according to the present disclosure using the training model structure illustrated in FIG. 4. FIG. 5 is a sequence diagram illustrating processing for determining channel access parameters by using an Artificial Intelligence (AI) and Machine Learning (ML) between the AP 101 and the STA 102 according to the present disclosure.

In the illustrated state, connection processing has been completed between the STA 102 and the AP 101 and that a channel access statistical information requesting and reporting procedures are able to be executed. This state has been obtained based on capability exchange in the connection procedure.

In step S501, the AP 101 requests the STA 102 for channel access statistical information.

The statistical information includes the number of re-transmissions, throughput, access delay, and jitter in unit time for each application.

In step S502, the STA 102 reports the channel access statistical information to the AP 101.

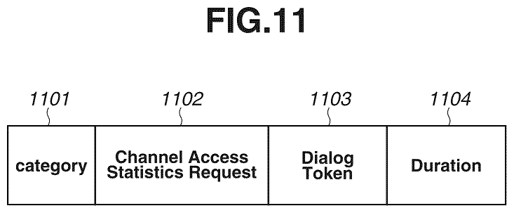

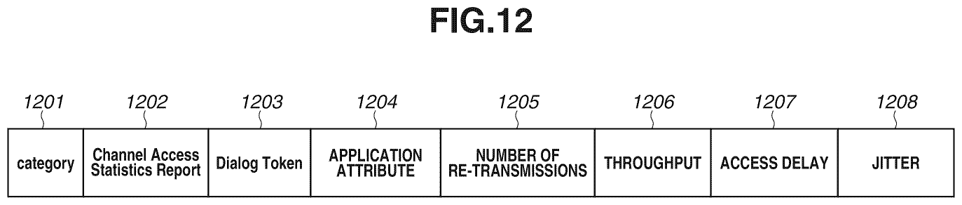

FIGS. 11 and 12 illustrates examples of frames for a statistical information request and a statistical information report in steps S501 and S502, respectively. The examples in FIGS. 11 and 12 use a Public Action frame prescribed in the IEEE802.11 standard.

Fields 1101 and 1201 indicate “Category”. In the present exemplary embodiment, “4” is stored in this area to indicate “Public” because of a Public Action frame.

A field 1102 defines new “Channel Access Statistics Request”. In a case where a channel access statistical information request is issued in step S501, “46” is set to the field.

A field 1103 is “Dialog Token” which is used to identify one request in occurrence of a plurality of requests.

A field 1104 indicates “Duration” which is a statistical value of a time duration.

A field 1202 indicates “Channel Access Statistics Report” to be newly defined. In a case where the channel access statistical information is notified in step S502, “47” is set to the field.

A field 1203 indicates “Dialog Token”. The use of this field is the same as that of the field 1103, and the redundant description will be omitted.

A field 1204 indicates “application attribute”.

A field 1205 indicates “the number of re-transmissions (or the number of collisions)”. This value is the average value or the number of times when the number of retries reaches a predetermined maximum value.

A field 1206 indicates “throughput”. This value is the average value or the ratio of the real throughput to the throughput performed by application.

A field 1207 indicates “access delay”. This value is the average value or maximum value.

A field 1208 indicates “jitter”. This value is the average value or maximum value.

Fields 1204 to 1208 store the value of the duration indicated by the field 1104.

To specify which of the average value or the maximum value is to be reported, a field 1105 (not illustrated) indicating the type of the reporting value may be provided in the request frame.

The operations in FIG. 5 will be described again below. In step S503, the AP 101 instructs the inference server 106 to update the channel access statistical information.

In step S504, the STA 102 requests the AP 101 for the channel access parameters.

In step S505, the AP 101 requests the inference server 106 for the inference values of the channel access parameters.

In step S506, the inference server 106 notifies the AP 101 of the inference values of the channel access parameters.

In step S507, the AP 101 notifies the STA 102 of the channel access parameters.

In step S508, the STA 102 executes wireless medium access (channel access) based on the received channel access parameters.

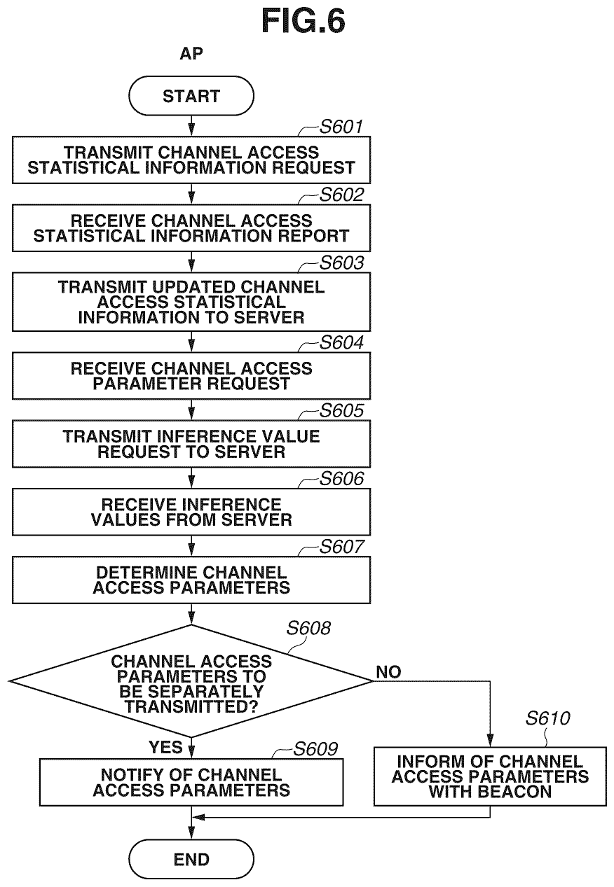

FIG. 6 illustrates a processing procedure implemented when the control unit 202 executes a program stored in the storage unit 201 of the AP 101 according to the present disclosure in the training and inference phases. This processing is implemented as steady state processing at the time of connection with the STA 102. Unless otherwise specified, the entity of operations is the AP 101.

In step S601, the AP 101 transmits a channel access statistical information request frame to the STA 102.

In step S602, the AP 101 receives the channel access statistical information report frame from the STA 102.

Steps S601 and S602 are a pair of steps called “request and report”. Instead of reporting as a response to a request, a step of direct reporting (unsolicited procedure), i.e., a step without step S601 is also applicable.

In step S603, the AP 101 transmits the channel access statistical information updated based on the information in step S602 to the inference server 106. Even in a case where the AP 101 has not received a request from the STA 102, in response to detection of a wireless channel state transition, the AP 101 reflects the contents of the state transition to the access statistical information and notifies the inference server 106 of the information.

In step S604, the AP 101 receives a channel access parameter request from the STA 102.

In step S605, the AP 101 transmits an inference value request to the inference server 106.

In step S606, the AP 101 receives the inference values of the channel access parameters from the inference server 106.

In step S607, the AP 101 determines the channel access parameters of the STA 102 based on the inference values of the received channel access parameters.

In step S608, the AP 101 determines whether to notify the STA 102 or notify all of BSS's of the determined parameters. In a case where the AP 101 determines to notify the STA 102 (YES in step S608), the processing proceeds to step S609. In a case where the AP 101 determines to notify all of BSS's (NO in step S608), the processing proceeds to step S610.

In step S609, the AP 101 notifies the STA 102 of the channel access parameters by using a unicast frame. Since the IEEE802.11be standard prescribes Emergency Preparedness Communications Service (EPCS) Priority Access as a scheme for separately applying the EDCA parameters, the AP 101 may use the scheme.

In step S610, the AP 101 informs the STA 102 of the channel access parameters at the Beacon transmission timing. In step S609, the AP 101 may simply indicate “informing with beacon”, and specific values may be omitted.

Meanwhile, the channel access parameters include EDCA parameters (or MU EDCA parameters) and parameters other than EDCA parameters. Parameters other than EDCA parameters include MCS, transmission power, and A-MPDU (step S607 indicates a case where the AP 101 does not particularly perform inference in response to a request from the STA 102). In this case, the AP 101 takes over the EDCA parameters that have been included in the Beacon frame so far. Then, the processing proceeds to step S608.

In step S608, the AP 101 notifies the STA 102 of the channel access parameters with Beacon. In a case where compatibility is considered, parameters that are able to be included in Beacon are EDCA parameters.

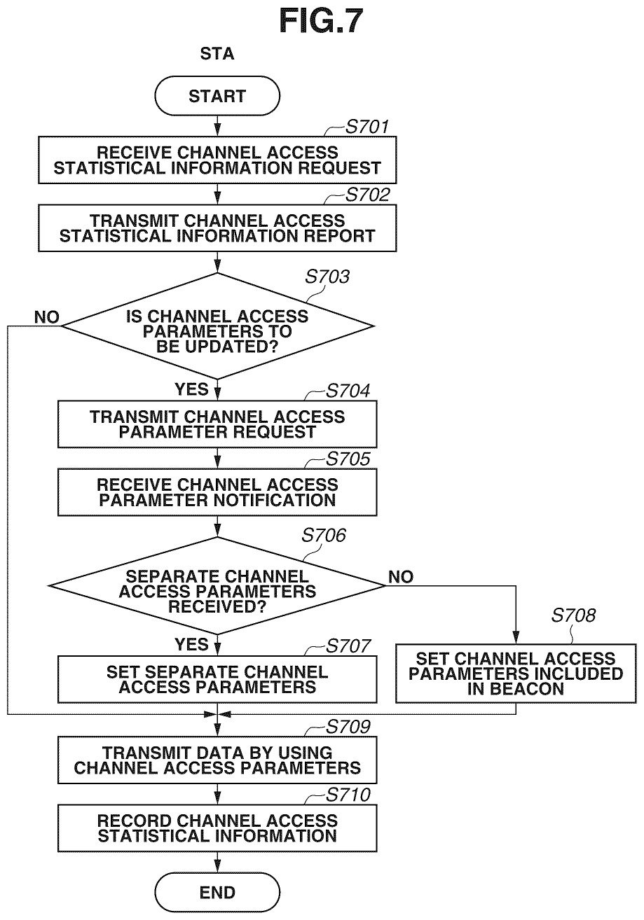

FIG. 7 illustrates a processing procedure implemented when the control unit 202 executes a program stored in the storage unit 201 of the STA 102 according to the present disclosure in the training and inference phases. Unless otherwise specified, the entity of operations is the STA 102.

In step S701, the STA 102 receives a channel access statistical information request from the AP 101.

In step S702, the STA 102 transmits a channel access statistical information report to the AP 101.

The STA 102 prepares for receiving the request in step S701 at any desired timing. The STA 102 may transmit the report in step S702 at any desired timing even without reception of the request in step S701.

In step S703, the STA 102 determines whether the channel access parameters are to be updated. In a case where the STA 102 determines that the channel access parameters are to be updated (YES in step S703), the processing proceeds to step S704. In a case where the STA 102 determines that the channel access parameters are not to be updated (NO in step S703), the processing proceeds to step S709.

In step S704, the STA 102 transmits a channel access parameter request to the AP 101.

In step S705, the STA 102 receives a channel access parameter notification from the AP 101.

In step S706, in a case where separate channel access parameters are received in step S705 (YES in step S706), the processing proceeds to step S707, and in a case where separate channel access parameters are not received in step S705 (NO in step S706), the processing proceeds to step S708.

In step S707, the STA 102 determines to use separate channel access parameters.

In step S708, the STA 102 receives Beacon and determines to use the EDCA parameters included in the Beacon as channel access parameters.

In step S709, the STA 102 transmits a data frame by using the set channel access parameters.

In step S710, the STA 102 records the transmission result as the channel access statistical information.

In a case where no notification is received from the AP 101 (NO in step S706), the processing may return to step S704. In this case, the processing does not need to proceed to step S708. More specifically, the STA 102 may perform control not to transmit the channel access parameters before determination of suitable channel access parameters.

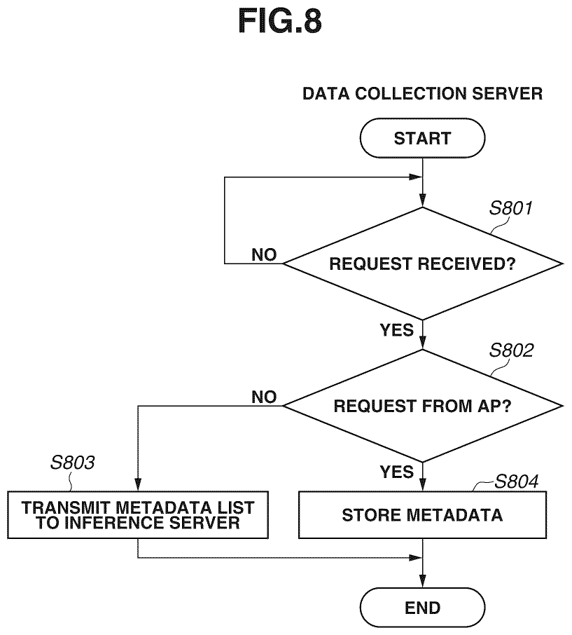

FIG. 8 is a flowchart illustrating a processing procedure of the data collection server 105 in the training and inference phases. The data collection server 105 is constantly performing this processing.

In step S801, the data collection server 105 waits for a request from the AP 101 or the inference server 106.

In step S802, the data collection server 105 determines whether a request is received from the AP 101 and changes the processing according to the transmission source of the request. In a case where the data collection server 105 determines that a request is received from the AP 101 (YES in step S802), the processing proceeds to step S804. In a case where the data collection server 105 determines that the request is not from the AP 101 (NO in step S802), the processing proceeds to step S803.

In step S803, which means that the request is from the inference server 106, the data collection server 105 determines that the request is a data list request for training and thus transmits the recorded metadata list to the inference server 106.

In step S804, which means that the request is from the AP 101, the data collection server 105 determines that the request is a metadata recording request for transmission to the data collection server 105 and stores the metadata. The criterion of the determination may be other than the transmission source address. For example, the contents of the request may be described in the request frame.

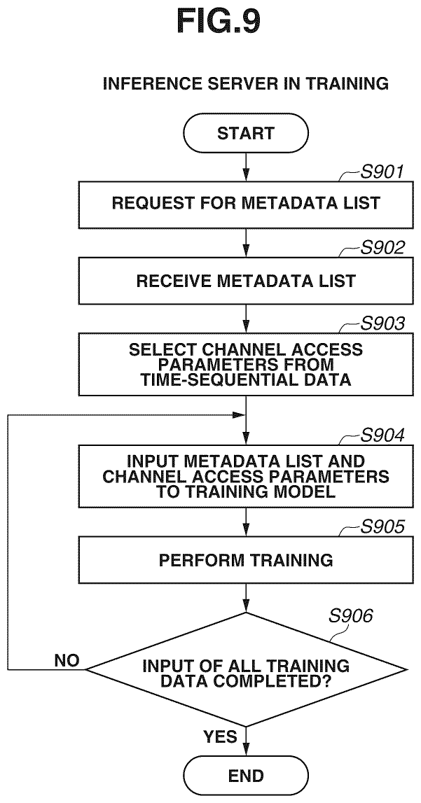

FIG. 9 is a flowchart illustrating a processing procedure of the inference server 106 in the training phase.

The inference server 106 may perform training on a periodical basis or after outputting of inference values in response to reception of an inference request from the AP 101.

In step S901, the inference server 106 requests the data collection server 105 for a metadata list. In step S902, the inference server 106 receives the metadata list from the inference server 106.

In step S903, the inference server 106 selects the channel access parameters from the time-sequential data.

The input data may be all data during a certain continuous period. The input data may be data collected by sampling at predetermined intervals.

In step S904, the inference server 106 inputs the metadata list and a result to the training model.

In step S905, the training unit 333 of the inference server 106 performs model data training processing based on the input parameters. For example, in a case where a training model is configured by using a neural network, the inference server 106 updates the coupling weighting coefficient between nodes of a convolutional neural network in such a manner that the output value of the neural network approaches a target value. Further, the inference server 106 determines the adjustment amount of the coupling weighting coefficient by using an error function that represents the error between the teacher data and the output value output by using the model data under training.

In step S906, the inference server 106 determines whether all of the data sets prepared in step S903 have been input. In a case where the inference server 106 determines that all of the data sets have been input (YES in step S906), the processing exits this flowchart. In a case where the inference server 106 determines that not all of the data sets have been input (NO in step S906), the processing returns to step S904. In step S904, the inference server 106 continues training of the model data based on the data sets not having been input. The inference server 106 repetitively performs the processing in steps S904 and S905 to gradually optimize the coupling weighting coefficient, whereby trained model data that outputs the output value having a small error from the target value is configured.

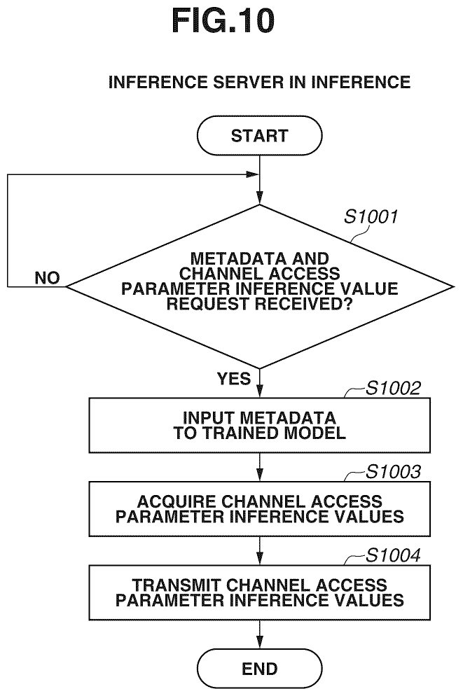

FIG. 10 is a flowchart illustrating a processing procedure of the inference server 106 in the inference phase. This processing is constantly executed.

In step S1001, the inference server 106 determines whether the input data and a channel access parameter inference value request are received from the AP 101.

In a case where the inference server 106 determines that the data and request are received (YES in step S1001), the processing proceeds to step S1002. In step S1002, the inference server 106 inputs the input data to the trained model. In a case where the format of the received metadata is different from the format of the input data, the inference server 106 converts the format of the metadata into the format of the input data via the training data generation unit 332.

By inputting the input data to the trained model in step S1002, in step S1003, the inference server 106 acquires the channel access parameter inference values from the training model.

In step S1004, the inference server 106 notifies the AP 101 of the channel access parameter inference values acquired in step S1003.

As described above, the AP 101 notifies the STA 102 connected via the frame conforming to the IEEE802.11 standard of the channel access parameters acquired by machine learning.

The present disclosure may be executed when the AP 101 and the STA 102 perform Multi-User Uplink (MU UL) communication conforming to the IEEE802.11ax standard. In this case, MU EDCA parameters are applied as the EDCA parameters.

Thus, output parameters may be the MU EDCA parameters. The MU EDCA parameters differ from the EDCA parameters in that MU EDCA Timer is prescribed instead of TXOP limit. This Timer value indicates a period during which AIFSN/CWmin/CWmax after successful UL communication via Trigger Frame (TF) is applied.

Fairness between terminals is used as input data (teacher data). Fairness refers to a condition where, when a plurality of STAs performs transmission with the same application attribute, all of the STAs have the same throughput and the same number of re-transmissions. This fairness is one of the basic functions to be achieved by the IEEE802.11 standard.

Feasibility of Quality of Service (QOS) may also be used as input data (teacher data). QOS refers to a function of assigning data to one of four different access categories (AC_VO: voice, AC_VI: video, AC_BE: best effort, and AC_BK: background) and executing priority control. This control is generally implemented by applying small AIFSN and CW to a frame with high priority. TXOP limit for the video category is to be set larger than that for the voice category. However, an unsuitable balance between the categories results in such a situation where video communication is disabled during execution of voice communication. Therefore, the AP 101 changes AIFSN/CW/TXOP limit based on the communication quality of the four different categories. QoS is one of the basic functions to be achieved by the IEEE802.11 standard.

Instead of an application attribute 1024, Traffic Specification (TSPEC) prescribed by the IEEE802.11 standard may be used. Each field of TSPEC includes the following information.

The Traffic Stream (TS) field includes the access category and Ack Policy (such as No ack and Block Ack).

The Nominal MSDU Size field includes the data size of the MAC layer.

The Maximum MSDU Size field includes the maximum data size of the MAC layer.

The Minimum Service Interval field includes the minimum interval of transmission and reception of two different traffics.

The Maximum Service Interval field includes the maximum interval of transmission and reception of two different traffics.

The Inactivity Interval field includes the time duration that can elapse without data reception and transmission. When the relevant time duration has elapsed, TS is deleted.

The Suspension Interval field stores information about the time during which polling from the AP is able to be stopped.

The Service Start Time field includes the start time of a traffic.

The Minimum Data Rate field includes the minimum data rate.

The Mean Data Rate field includes the average data rate.

The Peak Data Rate field includes the peak data rate.

The Burst Size field includes the burst size.

The Delay Bound field includes the delay information.

The Minimum PHY Rate field includes the minimum physical layer data rate.

The Surplus Bandwidth Allowance field includes information about the excessively required band width.

The Medium Time field is used to reserve the wireless medium to be used in the ADDTS procedure.

The DMG Attributes field is used in Directional Multi-Gigabit (DMG) BSS.

The above-described fields also include information not used in EDCA access, but have an advantage that the implementation load decreases by using the existing standard.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

The processor or the circuit may include a central processing unit (CPU), a micro processing unit (MPU), a graphics processing unit (GPU), an application specific integrated circuit (ASIC), or a field programmable gate array (FPGA). Also, the processor or circuit may include a digital signal processor (DSP), a dataflow processor (DFP), or a neural processing unit (NPU).

### Modifications

In the present exemplary embodiments, the standard name “IEEE802.11be” is exemplified as an example of the successor standard of IEEE802.11 HR, but the present invention is not limited thereto. For example, the standard name may be High Reliability (HRL), High Reliability Wireless (HRW), Very High Reliability (VHT), Ultra High Reliability (UHR), or the like. The standard name may be Low Latency (LL), Very Low Latency (VLL), Extremely Low Latency (ELL), or Ultra Low Latency (ULL). The standard name may be High Reliable and Low Latency (HRLL). The standard name may be Ultra-Reliable and Low Latency (URLL). The standard name may be any name other than the above listed.

The communication apparatus of the present disclosure makes it possible to perform data collection and data communication for the data collection to be utilized in machine learning in channel access.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
at least one memory storing instructions; and
at least one processor configured to execute the instructions stored in the at least one memory to cause the communication apparatus to perform:
transmitting a channel access parameter request to a server, a part of information or all pieces of information from among time-sequential data of any one of pieces of information in unit time being included in the channel access parameter request, the information including an application attribute, the number of stations (STAs) connected to an access point (AP), a channel usage rate, the number of re-transmissions, a throughput, an access delay, jitter, fairness, Quality of Service (QOS), and Traffic Specification (TSPEC) information prescribed in IEEE802.11, wherein the request requests for inference of channel access parameters to be used for communication between the communication apparatus and other communication apparatus;
acquiring the channel access parameters from the server; and
notifying the other communication apparatus of the channel access parameters acquired from the server.

2. The communication apparatus according to claim 1, wherein the channel access parameters are a combination of Enhanced Distributed Channel Access (EDCA) parameters, MU EDCA parameters, Modulation and Coding Scheme (MCS), Medium access control Protocol Data Unit (A-MPDU), and transmission power.

3. The communication apparatus according to claim 1,
wherein the at least one processor further executes the instructions stored in the at least one memory to cause the communication apparatus to perform:
transmitting changes of the channel access parameters to the server.

4. The communication apparatus according to claim 1, wherein the channel access parameters are acquired by inference that is performed by the server based on the information included in the request and trained model data stored in the server.

5. A communication method of a communication apparatus comprising:
transmitting a channel access parameter request to a server, a part of information or all pieces of information from among time-sequential data of any one of pieces of information in unit time being included in the channel access parameter request, the information including an application attribute, the number of stations (STAs) connected to an access point (AP), a channel usage rate, the number of re-transmissions, a throughput, an access delay, jitter, fairness, Quality of Service (QOS), and Traffic Specification (TSPEC) information prescribed in IEEE802.11, wherein the request requests for inference of channel access parameters to be used for communication between the communication apparatus and other communication apparatus;
acquiring the channel access parameters from the server; and
notifying the other communication apparatus of the channel access parameters acquired from the server.

6. A non-transitory computer readable storage medium storing a program to cause a computer to perform:
transmitting a channel access parameter request to a server, a part of information or all pieces of information from among time-sequential data of any one of pieces of information in unit time being included in the channel access parameter request, the information including an application attribute, the number of stations (STAs) connected to an access point (AP), a channel usage rate, the number of re-transmissions, a throughput, an access delay, jitter, fairness, Quality of Service (QOS), and Traffic Specification (TSPEC) information prescribed in IEEE802.11, wherein the request requests for inference of channel access parameters to be used for communication between the communication apparatus and other communication apparatus;
acquiring the channel access parameters from the server; and
notifying the other communication apparatus of the channel access parameters acquired from the server.
